(19) United States
(12) Patent Application Publication
(10) Pub. No.: US 2017/0294133 A1
(43) Pub. Date: Oct. 12, 2017

(54) Arrangement and method for online learning

(71) Applicant: Acament Oy, Espoo (FI)

(72) Inventors: Kari Jääskeläinen, Espoo (FI); Kimmo Pennanen, Jyväskylä (FI)

(73) Assignee: Acament Oy, Espoo (FI)

(21) Appl. No.: 15/485,256

(22) Filed: Apr. 12, 2017

Related U.S. Application Data
(60) Provisional application No. 62/321,314, filed on Apr. 12, 2016.

(51) Int. Cl. G09B 5/08; G09B 7/08; G09B 5/14

(52) U.S. Cl. CPC G09B 5/08; G09B 5/14; G09B 7/08; G09B 5/00

(57) ABSTRACT

Electronic arrangement comprising at least one electronic device or a system of multiple at least functionally connected electronic devices, comprising data repository configured to store digital online course material for distance learning, provided by a plurality of content providers, said digital course material encompassing course content divided into a plurality of different learning objectives, said digital course material being further arranged into a plurality of separately accessible digital data ensembles each of which addressing a learning objective of said plurality, wherein each learning objective of said plurality is covered by at least one of the plurality of ensembles, and wherein at least one learning objective of said plurality, optionally each learning objective of said plurality, is covered by multiple alternative data ensembles of the plurality of ensembles, online platform configured to provide online access to a plurality of users regarding said stored digital course material including the plurality of digital data ensembles and communicate indications of multiple alternative ensembles covering said at least one learning objective for enabling related user selection, access monitor for tracking the usage including access of said digital course material during a selected monitoring period, wherein tracking comprises detecting and storing user-specifically both at least an indication of accessed data ensembles and the cumulative number of related access times per ensemble, and usage analyzer for determining, based on the stored user-specific indications regarding the monitoring period, user-specific rewards for a content provider of said plurality of providers, and preferably total reward based on the user-specific rewards. Method to be executed by the arrangement is presented.

### PRIORITY

This application claims priority of the provisional application U.S. 62/321,314 which was filed on Apr. 12, 2016 and the contents of which is incorporated herein by reference.

### FIELD OF THE INVENTION

The present invention relates generally to digital devices, communications, related applications and services. Particularly, however not exclusively, the invention pertains to digital online education environment for self-learning with user-selectable content.

### BACKGROUND

Recently online learning and other forms of digital education, or e-learning, have generally taken ground from more traditional printed media and on-the-ground courses. Online learning is a form of distance learning and typically refers to the ‘online’, i.e. Internet, backbone used as the main technological medium and context for the provision of the overall learning experience and related content. A myriad of online learning facilities such as courses on various topics have emerged as offered by different institutions, course organizers, universities, high schools and academies.

Somewhat typically online learning takes place via client software installed at a terminal device, such as a ‘web browser’ or simply a ‘browser’. The learning material may be distributed to the browser through ordinary web (WWW, world wide web) pages following a selected version of the HTML (hypertext markup language) standard and possibly utilizing e.g. Javascript™ command line language and various browser extensions for providing the users with versatile and flexible learning experience. The experience may incorporate e.g. text, graphics, and audio/video type digital content. The material may thus establish a web page or a web site of multiple pages, or a digital slideshow, which may include various interactive features for communication or control purposes.

Current online learning environments suit both for real-time streaming of lectures or other learning sessions, where the remote participants may also personally come in the related discussions and communicate with each other or the lecturer in real-time fashion, and more self-governing studying of ready-made educational materials by each individual at his or her convenience.

Commonly, having regard to e.g. a university level course on a selected topic, the associated digital or potentially merely printed materials have been prepared by a responsible person, e.g. a responsible professor or tutor. The materials have been usually constructed so as to cover the substance of the overall course or similar study module with focus and means of representation that appear most appropriate and convenient to the author, i.e. the professor or tutor, alone. Some general guidelines or requirements about the format and style of the deliverables may have been additionally determined by a course organizer and the used (online) learning platform that may support certain selected client software such as browsers and native client applications only.

Technically the above simplistic approach for designing and offering e.g. digital course materials is naturally feasible and generally even works acceptably well in a sense that at least some sort of course material supporting distance learning students becomes available and enables the students to get a grasp of the underlying topics.

However, one major problem resides in the diversity of human mind and way of thinking. For example, some of us prefer visual learning while others are keener on aural, kinesthetic or comprehensive multiform learning experience. On the other hand, some people like to analyze things and learn based on associated details whereas the rest are eager to received summarized data that can be then deconstructed for further details when necessary.

Therefore, a single material set may, perhaps, statistically serve for an average student adequately, but in reality, it is hardly optimal for anybody in terms of ease or efficiency of learning.

Even if the authors of the learning materials are later supplied with a good deal of feedback from the students for revising and developing the materials further in terms of the manner of representation or e.g. level of detail, the aforesaid fundamental problem of diversity will remain. Indeed, what works for one may be hated by the others. Therefore, feedback-based iteration and cultivation of the learning material based on user feedback works only on average. This questionable benefit or other existing incentives, typically actually almost complete lack thereof, do not really spur the authors to work on updated materials. Accordingly, the quality of course materials constructed by the responsible authors may stay both objectively, in terms of technical quality and coverage, and subjectively, from the standpoint of individual users, sub-optimal. Even the personal reputation of the authors may subsequently deteriorate from sub-optimal material prepared, first among the material users and later through grapevine.

### SUMMARY

It is the objective of the present invention to at least alleviate one or more of the above drawbacks or challenges related to the prior art arrangements in the context of distance and especially online type learning environments.

The objective is achieved by the various embodiments of a method and an arrangement in accordance with the present invention.

In one aspect, an electronic arrangement comprising at least one electronic device or a system of multiple at least functionally connected electronic devices, comprises

data repository configured to store digital online course material for distance learning, provided by a plurality of content providers, said digital course material encompassing course content divided into a plurality of different learning objectives, said digital course material being further arranged into a plurality of separately accessible digital data ensembles each of which addressing a learning objective of said plurality, wherein each learning objective of said plurality is covered by at least one of the plurality of ensembles, and wherein at least one learning objective of said plurality, optionally each learning objective of said plurality, is covered by multiple alternative data ensembles of the plurality of ensembles,
online platform configured to provide online access to a plurality of users regarding said stored digital course material including the plurality of digital data ensembles and communicate indications of multiple alternative ensembles covering said at least one learning objective for enabling related user selection,
access monitor for tracking the usage including access of said digital course material during a selected monitoring period, wherein tracking comprises detecting and storing user-specifically both at least an indication of accessed data ensembles and the cumulative number of related access times per ensemble, and
usage analyzer for determining, based on the stored user-specific indications regarding the monitoring period, user-specific rewards for a content provider of said plurality of providers, and preferably total reward based on the user-specific rewards.

In another aspect, a method for embracing online self-studying-based distance learning to be executed by one or more at least functionally connected electronic devices, the devices preferably comprising at least one server accessible via a communications network, advantageously the Internet, comprises

storing, at a digital data repository accessible and optionally hosted by the devices, digital course material by a plurality of content providers, said digital course material encompassing course content divided into a plurality of different learning objectives collectively covering the content, said digital course material arranged into a plurality of separately accessible digital data ensembles each of which addressing at least one, preferably exactly one, learning objective of said plurality, such as digital files or records for constituting a visual, audio or multimedia presentation or at least one web page,
wherein each learning objective of said plurality is covered by at least one of the plurality of ensembles, and wherein at least one learning objective of said plurality, optionally each learning objective of said plurality, is covered by multiple alternative data ensembles of the plurality of ensembles,
providing online access to said digital course material including the plurality of digital data ensembles for a plurality of users, wherein indications of multiple alternative ensembles covering said at least one learning objective are communicated online for user selection,
tracking the usage including access of said digital course material during a selected monitoring period, wherein tracking comprises detecting and storing user-specifically both at least an indication of accessed data ensembles and the cumulative number of related access times (events or sessions) per ensemble, where there may optionally be allocated a plurality of successive monitoring periods together substantially spanning the overall course period, and
determining, based on the stored user-specific indications regarding the monitoring period, user-specific rewards for a content provider, preferably for each content provider, of said plurality of providers, and preferably total reward based on the user-specific rewards.

The various considerations presented herein concerning the embodiments of the method may be flexibly applied to the embodiments of the arrangement mutatis mutandis, and vice versa, as being naturally appreciated by a person skilled in the art.

The utility of the present invention arises from a variety of features depending on each particular embodiment thereof.

First, as the alternative, or ‘competing’, materials or generally content items (technically herein considered as digital data ensembles) concerning the same learning objective are flexibly offered to the users via a common digital platform and medium, each user may conveniently pick up his or her desired choice of material, try different materials, revert to the particular material whenever needed and even simultaneously access several alternative materials to get a full picture of the underlying topic. The competing materials are typically provided by different authors, or generally ‘content providers’, and very likely, and in most cases preferably, thus apply different emphasis, representation techniques and style, language, etc., whereupon users with different preferences on learning techniques (e.g. visual vs. aural) may find the material that best suits their needs. Best talents may be locally or globally recruited for supplying the content depending on the course goals even learning objective specifically.

As the course content is provided via online system basically accessible on 24/7 basis and location independently by ordinary terminal devices such as desktop computers, laptop computers, tablets, phablets, smartphones and other applicable electronic client-side equipment, the users may self-study the selected course materials covering all the required learning objectives in the ensemble modules of their personal choice more effectively and easily than ever before. Accordingly, the associated effort in terms of time and expenses may be minimized and general information adoption level considerably improved.

Further, the users may instead of or in addition to autonomously wading through different alternative content, inspect and rely on community and optionally system operator-originated informative data, which can be realized as content item (data ensemble) or content provider rankings (e.g. ‘top ten’), various ‘featuring’ lists, recommendations, etc. established based on the automated tracking of user behavior, such as content access, and feedback explicitly provided or deduced based on other user behavior. In some embodiments, personal preferences, which may be explicitly input to the platform by the users themselves e.g. via the UI and/or implicitly deduced from the recorded online behavior including study history, may be exploited in the provision of content including e.g. filtering or ordering of offered content items. For example, provision of audible content options may be prioritized (e.g. shown first or highlighted) over visual content options in case the concerned user is an aural learner, or vice versa in the case of a visual learner. Different aspects of collaborative, or social, filtering may be applied in predicting content items a user may prefer over other alternatives. Similarities between several users may be recognized having regard to e.g. content usage and/or explicitly input user preferences, whereupon one user may be offered, with a higher priority (e.g. presented spatially or temporally first) a content item that was already accessed and preferably positively judged by at least one other user considered similar according to selected criteria, for example.

Various embodiments of the present invention may be harnessed to apply selected methods of cognitive AI (artificial intelligence) or cognitive modeling (profiling) to track content usage, determine user preferences and provide e.g. related content recommendations or prioritization.

In some embodiments to automatize e.g. the composition of neural network(s) or other applied AI modeling technology for question answering, the content providers of the learning material, such as teachers, are first asked a set of questions related to the material they are uploading. This database of question-answer pairs related to the material is then utilized by the selected AI solution to subsequently provide content recommendations or prioritization based on the questions input to the AI by users such as course attendants.

Yet, as the content providers are indeed rewarded based on the automatically monitored actual usage of their materials and optionally also on user feedback received, they will have a clear incentive to optimize and possibly revise or update the materials from the standpoint of both educational and pedagogic objectives, which usually improves the quality of the deliverables in a longer run. The rewards may include financial or non-financial, e.g. digital content based rewards. Especially positive feedback and the overall number of accesses the materials of a content provider has constructed receive may convert into even a greater amount of accesses of his/her materials in the future, which ultimately adds to the reward as well and also fame of the provider via e.g. content/content provider rankings. Favorable rankings or grades may be then adopted in the CV's and publication lists of the content providers. On the other hand, negative feedback may ultimately blemish one's reputation, whereupon a responsible content provider is typically motivated to rapidly revise the criticized material.

Still, the provided technical solution may be fully automated in terms of material submissions, online access provision, feedback acquisition, usage tracking, reward determination and execution, creation of content and content provider rankings/recommendations, etc.

Various additional benefits of different embodiments of the present invention will become clear to a person skilled in the art based on the detailed description hereinbelow.

The expression “a number of” may herein refer to any positive integer starting from one (1).

The expression “a plurality of” may refer to any positive integer starting from two (2), respectively.

The terms “grade” and “rating” are herein utilized substantially interchangeably if not explicitly stated otherwise.

Different embodiments of the present invention are disclosed in the attached dependent claims.

### BRIEF REVIEW OF THE DRAWINGS

Few embodiments of the present invention are described in more detail hereinafter with reference to the drawings, in which

FIG. 1 illustrates an arrangement and elements potentially connected thereto in accordance with an embodiment of the present invention.

FIG. 2 is a block diagram representing the internals of an embodiment of the arrangement.

FIG. 3 is a flow diagram disclosing an embodiment of a method in accordance with the present invention.

FIG. 4 illustrates an embodiment of depicting course contents including learning objectives to the users.

FIG. 5 illustrates an embodiment of data ensemble information display.

FIG. 6 illustrates an embodiment of data ensemble feedback or review feature incorporating a rating tool and a free text field.

FIG. 7 illustrates an embodiment of data ensemble selection feature.

FIG. 8 illustrates an embodiment of content provider ranking, or ‘top list’, feature.

FIG. 9 illustrates an embodiment of award estimation feature.

FIG. 10 illustrates an embodiment of award determination feature.

### DETAILED DESCRIPTION

Having regard to various embodiments of the present invention, although the present invention is primarily intended for supporting distance learning and self-studying in scenarios where the students or generally users may be spatially spread across a city, state, country, continent or even the globe, the suggested solution is technically completely suitable for embracing hybrid education and pure on-site education as well. In hybrid scenarios the users that most likely take advantage of the suggested solution are the remote ones but also in a common studying space like classroom or lecture hall the solution could find at least limited use when the students are authorized to study some topic more independently for a while.

The solution of the invention may be set up by an institution such as a company, a university, a high school, a city, a private person, or some other entity. It may be offered as the sole or main format of studying the topic in question, or it may only have a supporting role. The term ‘course’ may refer herein to any structured education scheme with a general theme or content that is divided into a plurality of learning objectives that may be studied one at a time via a plurality of preferably dedicated materials. The course may thus be of official or more generally recognized nature, e.g. university course fitting a certain curriculum, or it may be unofficial and organized by one or more enthusiasts of the particular topic only. The course or the suggested associated online solution may be chargeable or free of charge to the users.

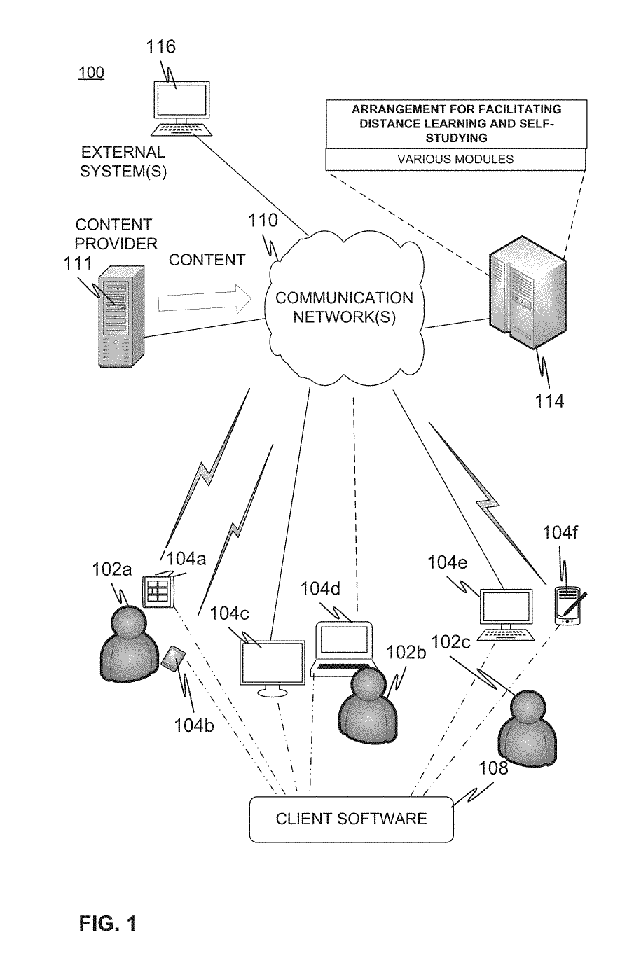

FIG. 1 illustrates, at 100, an embodiment of the arrangement 114 in accordance with the present invention and related connected elements and entities. The arrangement 114 may, in turn, be adapted to execute an embodiment of a method in accordance with the present invention. The arrangement 114 contains a number of elements, or ‘modules’, for providing a desired online distance learning solution with alternative course materials for the users.

The arrangement 114 typically includes at least one server that hosts a data repository such as one or more at least functionally connected databases or other data storing structures such as computer program(s), where the storage method itself may refer to hard disc technology, optical storage (e.g. optical discs) and/or various memory chips. The repository may thus hold data such as course content in the form of several digital data ensembles each covering at least one and in many practical circumstances advantageously only one learning objective of the course, where the ensembles together make up the overall course material or at least substantial part thereof.

A digital data ensemble may refer to an electronically and particularly digitally stored file or a plurality of files constituting together the necessary substance for (self-)studying the related learning objective. Instead of or in addition to one or more dedicated files, the ensemble may include data records integral with a number of more general or shared data structures. An ensemble may refer to at least one text, video, audio, and/or multimedia data element/file defining as such or with the aid of a more generic content representation engine (e.g. application, service) the substantive content for studying the learning objective. For example, the ensemble may at least include or at least partially define a web page, a web site, an aggregate of HTML code, a document or generally file such as a Powerpoint™ document, a Macromedia Flash™ document, or a PDF™ document, and/or document/file following some other potentially proprietary format(s).

The arrangement 114 further includes an online platform suitable for distributing the course content such as general course content (e.g. description, participant and lecturer related data) and learning objective-related data ensembles. The platform may be at least partially realized through the utilization of e.g. existing proprietary or open-source software that is preferably modified or expanded, through communication with other programs or similar entities, to cater for the preferred additional features of the solution suggested herein.

The platform may specifically include a targeted online learning platform that provides for downloading and potentially uploading course content as well as ranking content and/or content providers, giving feedback, analyzing usage of course material, etc.

Preferably the platform implements an online UI (user interface) by a web browser or other (terminal) client application-perceivable or, in terms of audio/multimedia material, accessible digital environment. For example, the platform may incorporate a web server (HTTP server or HTTP based server) or a server-run web service application, with desired extensions. The server or service may optionally be cloud-based, which adds to the scalability thereof. The UI provided by the platform may have inherent support for different terminals through serving the course data with related rendering instructions, e.g. specific stylesheets.

The platform may be configured to distribute the content in real-time fashion only through suitable form of streaming and/or through disabling full or permanent content download, for example. In other embodiments, in addition to online viewing also offline access of the content items such as the data ensembles could be enabled by allowing the content items to be downloaded and stored as a whole, for example.

In addition to the data repository and online platform, the arrangement 114 comprises a number of further modules that may be physically integrated with or implemented separately from the platform software, including e.g. a resource or access monitor for tracking the usage of the arrangement and especially content distributed therewith, and analyzer for determining, based on the usage and e.g. feedback data, different rankings or recommendations and/or content provider rewards.

The arrangement 114 is functionally, at least communications-wise, connected to one or more communications networks 110 that may include various private and/or public data networks, e.g. cellular networks. Preferably, the arrangement 114 is in particular functionally connected to the Internet for achieving practically best coverage for content distribution being currently available.

Through the network(s) 110 such as the Internet, a plurality of users 102a, 102b and 102c may access the content such as course materials provided by the arrangement 114. For the purpose, each user 102a, 102b, 102c may have access to one or more electronic terminal devices 104a, 104b, 104c, 10d, 104e, 104f that may be personal devices or shared devices. Likewise, the devices may be hardware-wise or e.g. software-wise multi-purpose generic devices or application-specific devices 114. The applicable devices may include, by way of example only, portable terminals such as a tablet 104a, a phablet or a communications-enabled PDA (personal digital assistant) 104f, a smartphone 104b, a smart television 104c, a laptop computer 104d or a desktop computer 104e, for example. Further, e.g. wearable electronics or terminals such as wristop computers could be utilized.

Depending on the embodiment of the arrangement 114, the terminal devices may require installation of general use or dedicated client software, or application, 108 to access the course content as alluded to hereinbefore. In some cases, the aforesaid web browser software optionally supplemented with necessary extension(s) is sufficient whereas in some other embodiments, the use of a specific dedicated client application may be necessary depending e.g. on the content format, security issues or online/offline usability factors. A person skilled in the art shall obviously understand the related tradeoff between maximizing user experience, such as content downloading or rendering speed, and the general accessibility and availability of the content, while picking out e.g. broadly available but perhaps sub-optimal readily available solution (e.g. web browser-based access) over more specific but potentially also more cultivated and sophisticated approach (e.g. native client application-based access), or vice versa.

Item 111 refers to content provider equipment, e.g. a terminal or server device, that is used to access the arrangement 114 to, for instance, upload course material such as data ensembles for online use. Also potential rewards, if embodied in digital form, could be signaled (communicated) to the content provider via the equipment 111 and communications connection(s) such as networks 110 between it 111 and the arrangement 114. Naturally each content provider may have equipment 111 of his/her own, which is not however depicted in the figure for clarity reasons.

Item 116 refers to various external system(s) 116 possibly interacting with the arrangement 114, which may include banking or generally financial transaction management systems, ERP (enterprise resource planning) systems, CRM (customer relationship management) systems, control systems, reporting systems, etc.

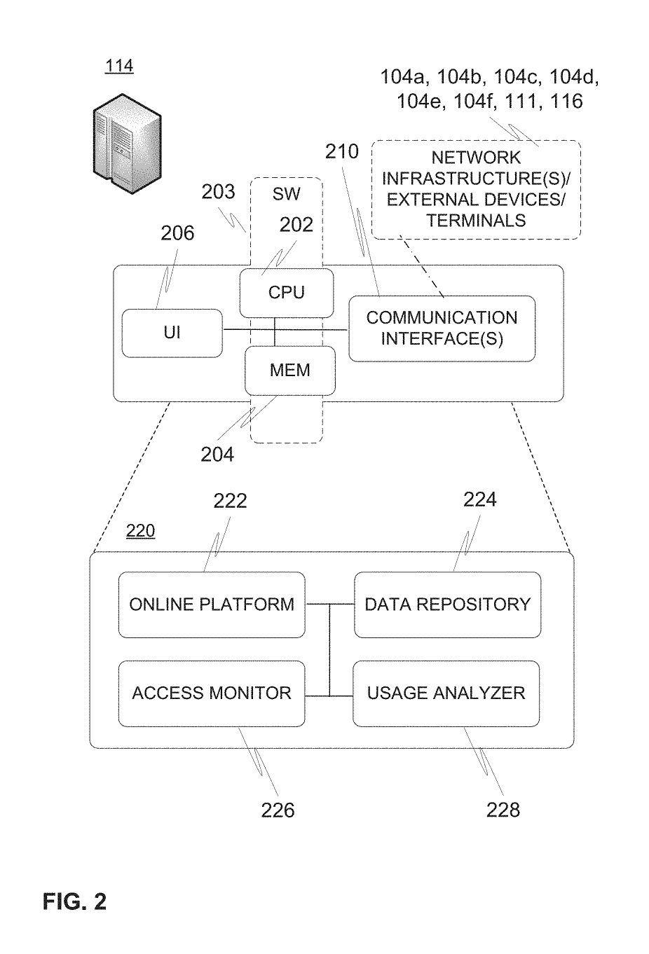

FIG. 2 is a block diagram representing the internals of an embodiment of the arrangement.

The arrangement 114 may be physically established by at least one electronic device, such as a server computer. The arrangement 114 may, however, in some embodiments comprise a plurality of at least functionally connected devices such as servers and optional further elements, e.g. gateways, proxies, data repositories, firewalls, etc. At least some of the included resources such as servers or computing/storage capacity or communications providing equipment in general may be dynamically allocable from a cloud computing environment, for instance.

At least one processing unit 202 such as a microprocessor, microcontroller and/or a digital signal processor is included. The processing unit 202 may be configured to execute instructions embodied in a form of computer software 203, practically a number of applications, stored in a memory 204, which may refer to one or more memory chips or generally memory units separate or integral with the processing unit 202 and/or other elements. The software 203 may be configured to operate the online platform and perform related management of course content access, usage monitoring, feedback analysis, reward determination, and derivation of ranking or grade data, for example.

A computer program product comprising the appropriate code means for the software 203 may be provided. It may be embodied in a non-transitory carrier medium such as a memory card, an optical disc or a USB (Universal Serial Bus) stick, for example. The program could be transferred as a signal or combination of signals wiredly or wirelessly from a transmitting element to a receiving element such as the arrangement 114.

A UI (user interface) 206 may provide the necessary control and access tools for controlling the operation of the arrangement 114. Operators of the arrangement 114 may be naturally provided with control means different from the ones allocated to standard users (students) or e.g. content providers. The UI 206 may include components for local data input (e.g. keyboard, display, touchscreen, mouse, voice input) and output (display, audio output) and/or remote input and output preferably via a web interface. The arrangement 114 may thus host or be at least functionally connected to a web server, for instance.

Accordingly, the depicted communication interface(s) 210 refer to one or more data interfaces such as wired network (e.g. Ethernet) and/or wireless network (e.g. wireless LAN (WLAN) or cellular) interfaces for interfacing a number of external devices such as user terminals and external systems with the arrangement of the present invention for data input and output purposes, potentially including control and management actions. The arrangement 114 is preferably connected to the Internet for globally enabling easy and widespread communication therewith. It is straightforward to contemplate by a skilled person that when an embodiment of the arrangement 114 comprises a plurality of functionally connected devices, any such device may contain a processing unit, memory, and e.g. communication interface of its own.

When considered from a functional standpoint, see the lower block diagram at 220, the arrangement 114 comprises a number of functional modules, which could also be physically realized in a variety of other ways depending on the embodiments, e.g. either by larger modules covering a greater number of functionalities or by smaller modules concentrating on a fewer number of functionalities per module. The modules may contain program code or instructions and other data stored in the memory 204. The actual execution may be performed by the at least one processing unit 202.

Potential tasks of an online platform 222 module have been already contemplated hereinbefore. The platform 222 may implement e.g. web server and/or web service configured to provide access to course content for the users via a suitable UI.

Data repository 224 for hosting data has also been discussed hereinbefore. It refers to data storing structures such as databases that hold e.g. digital data ensembles constituting the learning material of the course content.

Yet, the repository 224 includes further data for the cultivation of online course environment, related use experience and associated administrative activities such as execution of rewarding scheme tasks, including e.g. feedback data, usage data, ranking data, recommendation data, user data (e.g. user account data with related credential information, preferences information), content provider statistics, reward data (e.g. indication of determined rewards for content providers), etc.

A resource, or access, monitor 226 is configured to track the usage of course materials including data ensembles. Tracking may be implemented by detecting and logging access times of the ensembles preferably user-specifically, whereupon log data regarding the accessed ensembles and ensemble-specific number of related accesses is gathered. Further, in some embodiments indications of session durations are detected and stored as well (e.g. access start time, end time, and/or directly the session duration between the two) preferably data ensemble-specifically. In alternative embodiment, only accesses, or sessions, exceeding selected threshold duration are ultimately counted in by the monitor 226.

A usage analyzer 228 is configured to determine the user-specific rewards or reward shares for a content provider based on the data gathered or derived by the monitor 226. The total (overall) reward may be then determined by summing up the user-specific rewards for the provider. The analysis such as determination of the rewards may take place periodically. For example, the tracking data may be collected and reported per a monitoring period, e.g. a day, week, month or year, whereupon also the related analysis may apply the same period for period-specific reward determination. The analyzer 228 may further be arranged to determine data ensemble or content provider related grades and/or rankings.

The outcome of reward determination may be signaled e.g. by the online platform or the analyzer to element(s) internal and/or external to the arrangement 114 for information and/or furnishing the concerned content provider with the reward such as financial payment or elevated user right/access to a digital resource such as digital system, service, file, database, etc.

In some embodiments, the reward may include a digital data ensemble review or a generally content provider review or ranking with positive message such as implicit or explicit recommendation or other positive characterization depending on the nature or amount of accesses and/or feedback of the data ensemble(s) supplied by the provider. As such opinion is issued by a trustworthy party such as the operator or owner of the arrangement, it may have substantial weight in contrast to e.g. isolated user reviews included in user feedback. The reward may be accessible or perceivable via the arrangement 114 or external system 116.

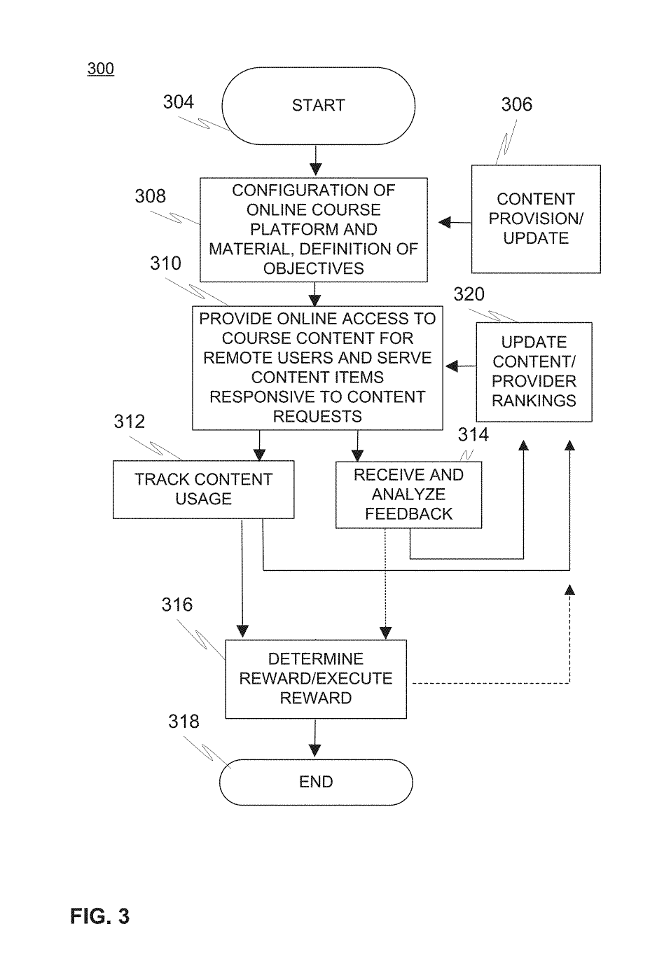

FIG. 3 shows a flow diagram 300 disclosing an embodiment of a method in accordance with the present invention.

Although the shown diagram contains a plurality of definite method items, in various other embodiments all the same items do not have to present. There may be additional method items as well that are not shown in the figure.

At method start-up 304, different preparatory tasks may be executed. For example, the hardware such as server(s) for hosting the online platform, related usage monitor, analyzer, and content repository may be obtained. The needed communication connections and links may be established and tested. User terminals may be provided with necessary additional software for accessing the online platform and digital course content, if necessary.

At 306, course material in the form of a plurality of digital data ensembles is obtained. Preferably each ensemble such as a multimedia file relates to a certain learning objective of the defined course content. Preferably there is at least one ensemble for each objective in the material. Yet, there preferably are alternative ensembles for one or more objectives with more or less mutually different characteristics (e.g. substance, form of representation, etc.) to cater for different styles, methods and preferences of learning. A data ensemble may be associated with metadata that describes the content of the ensemble, e.g. the underlying learning objective, presentation format, style or technique (e.g. visual, textual, graphical, audio, multimedia), content provider, language, version, publication date, feedback and/or ranking data, etc. Metadata may be made at least partially available to the users.

For example, course content, or ‘course curriculum’, may be divided into e.g. about 100 to 300 learning objectives for each of which there should preferably be studying material in the form of at least one data ensemble available. A single ensemble may optionally cover one objective only. The dividing procedure could in some embodiments be at least partially automated based on predefined course contents instead of manual work. For example, based on available digital listing of course contents or course description following a selected format, the arrangement may be configured to output a desired number of learning objectives based on an automated clustering algorithm and e.g. operator-selected target number or range for the number of objectives.

The content providers such as professors, other teachers, tutors or other specialists of the concerned learning objective may upload the material or otherwise supply it, e.g. on a digital carrier such as a memory card or stick, to the arrangement 114, or the (human) operator of the arrangement 114, for optional processing such as format conversion and inclusion in the data repository of course material.

At 308, the platform for online (self-)studying is ramped up and configured. Users (students/learners) may be allocated the necessary user rights based on e.g. personal enrollment details. The users may optionally register in the userbase of the arrangement via the online interface by themselves and obtain credentials such as user ID and password for subsequently accessing the platform and course material. The platform may support SSO (single sign-on) access.

Later, the arrangement may be generally configured to control content access such that without first logging in using the credentials that are preferably user-specific and unique, at least some of the data ensembles constituting the course content cannot be accessed. Depending on the user rights associated with the credentials, access to the content may be controlled e.g. course-specifically. For example, a user may only access course material of courses he or she has already successfully enrolled on potentially subject to a fee,

At 310, the online platform is brought into operational status. Distribution of course content, i.e. digital data ensembles, begins responsive to data requests from remote users using e.g. web browsers at terminal devices as course data access clients.

In particular, alternative materials, i.e. alternative data ensembles, concerning a common learning objective may be indicated to the users based on the recommendation and/or feedback data such as grades associated therewith. For example, the mutual order of alternative ensembles, i.e. ranking, may depend on such data. Average grade or rating, which may refer to a number (e.g. Roman numeral) using a predefined scale or a symbolic grade, of the ensembles may be indicated.

Preferably the data ensembles that are recommended e.g. by the operator or have obtained generally better feedback, and have a better general ranking and related grade, are shown or indicated in some other manner with priority (e.g. temporally and/or spatially first) to the users. Optionally, the alternatives could be shown in decreasing order of priority starting from the top or on left side of the UI portion such as a browser view depicting the alternatives e.g. via screenshots, related titles and/or selected metadata.

Optionally prior to accessing a digital data ensemble, related more detailed data such as metadata may indeed be investigated by a user. The data may be shown adjacent to an indication such as a textual or graphical symbol (e.g. screenshot) of a data ensemble, e.g. below it, or accessing the more detailed data may require executing a further user action, optionally involving clicking on a symbol associated with the ensemble or hovering a cursor or stylus (e.g. finger) thereon, for example. As a response, a dedicated view or e.g. additional data window may be created to render the data such as average grade, potentially more detailed user-specific feedback left by others and/or description of the ensemble provided by the content provider or other party such as the operator of the arrangement (in which case the description may be or incorporate also a recommendation), which may then facilitate making the decision whether to access that particular ensemble or look for a personally more suitable alternative.

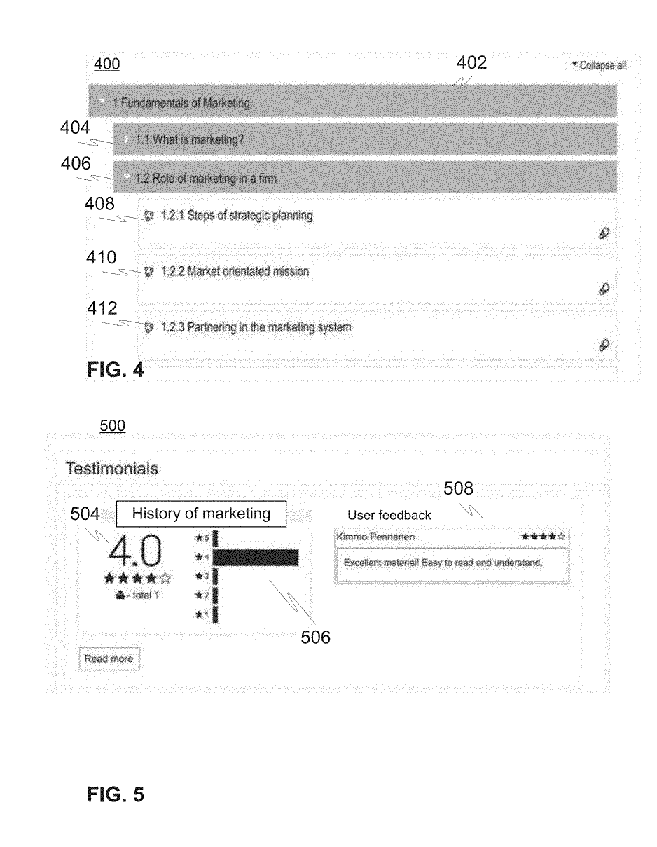

FIG. 4 illustrates one feasible embodiment of generally indicating, in this case visually as on-screen data, course contents to the users. The representation may adopt a hierarchy of a plurality of levels such as a course level 402, titles 404, 406, and underlying learning objectives 408, 410, 412. Preferably through a selection of a learning objective 408, 410, 412 (e.g. ‘click’ action on top of the title of the learning objective or related visually distinguishable element such as the overall rectangle encompassing the title), the selected objective 408, 410, 412 may be accessed either immediately (e.g. the highest ranked ensemble, if there are alternatives available) or via a further information view.

FIG. 7 illustrates an embodiment for data ensemble indication and selection. In this case a learning objective ‘Define marketing’ 702 contains three alternative, or ‘competing’, materials, i.e. data ensembles indicated as a vertical, generally list type, structure at 704. The ensemble with highest grade and therefore ranking (rated four (stars) out of five with one additional free-form feedback) is shown on top with the next highest ranking bearing alternative (three stars and 2 free-form comments available) adjacent below, etc. Preferably, a user may access a data ensemble of his/her preference by selecting a feature associated with it (e.g. icon, title text, representative screen area, etc.) as explained hereinabove.

FIG. 5 illustrates, at 500, data ensemble details in the form of metadata that may be in some embodiments established and preferably also communicated to the users based on e.g. gathered feedback data. In this particular embodiment the overall, e.g. average, grade 504 of the ensemble ‘History of marketing’ is shown using both numbers and symbols (stars, four out of five). Further, free-form textual feedback and related grades by individuals 508 are illustrated. Distribution of grades is indicated at 506 as well. In the shown case a bar diagram has been harnessed into that purpose but also e.g. pie chart or curve type representations are fully applicable.

In some embodiments, the users may be able to provide feedback anonymously at least in a sense that their real identity or e.g. account ID is not publicly indicated to other users.

Reverting to the flow diagram of FIG. 3, item 312 refers to tracking of content usage. As mentioned hereinbefore, user activity is preferably monitored and stored separately for each user at least having regard to a number of selected indicators.

For instance, indications of data ensembles (e.g. ensemble IDs) accessed by a user may be logged, optionally as metadata associated with the user data such as user account data and/or using a more general log.

In one practical implementation, as a user terminal sends a data ensemble request of predefined type (depending on the client program, e.g. HTTP GET via a web browser) to the arrangement typically responsive to user control input, and the arrangement responds by returning the requested data ensemble to the terminal of the user, a related log entry may be made concerning the user, the particular ensemble and the ongoing monitoring period. A (re-)programmable software probe may be configured to detect selected activities such as the receipt of aforesaid request at the arrangement, which then triggers execution of a number of further activities such as logging. Still, the logged data may incorporate counters so that when the same user accesses the same ensemble again, the ensemble- and user-specific counter value is increased to exhibit the overall, cumulative number of accesses by that user during the monitoring period. During the switchover between periods, such counters may be initialized to zero.

In addition to data ensemble-centric logging of data, the logged user-specific information may indicate more general statistics such as the overall number of different ensembles accessed or the overall number of accesses (of any one or more of the ensembles) during the period. Alternatively, such information may be derived from the ensemble-specific usage data afterwards by the analyzer. Time spent with a data ensemble may further be logged user-specifically or collectively concerning a plurality of users, such as all users.

At 316, a selected reward scheme is applied to determine personal (content provider-specific) rewards for supplying the course materials including data ensembles. Obviously the rewards may always include lump payments or regular fixed compensation.

According to more dynamic, alternative or supplementary, embodiment, however, for each user (student) a personal value such as a financial value of a single data ensemble access action (e.g. one ‘click’) may be first determined. One feasible option for determining the value on a financial basis is as follows:

(‘click’) value of an ensemble access action by a user during a monitoring period=tuition fee (overall or periodic, e.g. annual)/(duration in monitoring periods*overall number of accesses during the period), (1)

wherein

tuition fee refers to overall fee the user pays for his education covering one or more online courses, e.g. 600 eur, in overall or per term or per some other period, and

duration in monitoring periods refers to the number of monitoring periods the education, term or other period spans; e.g. three years equal to 36 months.

Now, for a content provider, who may serve a number of data ensembles, i.e. separately accessible and studiable content items, for a number of courses incorporated in the education, a user-specific reward per monitoring period may be determined through multiplication actions as:

reward to content provider=value of an ensemble access action of a user during a monitoring period*number of access actions by the user to the ensemble(s) of B during the monitoring period*optional additional multiplier(s) (2)

where additional multiplier(s) may refer to e.g. a share of the content provider from the tuition fee, e.g. 30 percent corresponding to 0.3. The additional multiplier may thus define how the income (course, term or education fee) is shared among e.g. the course operator and content provider(s).

As a tangible example, a potential use scenario is next considered.

Student ‘A’ has accessed “How to define marketing” video (data ensemble) of content provider ‘B’ for five times whereas ‘A’ has also accessed other materials of other content providers for 15 times during a past monitoring period of one month.

The reward for content provider ‘B’ based on the activities of student ‘A’ alone in the light of the other above, merely exemplary, parameter values (three year education, total cost 600 eur, share multiplier 0.3) thus are:

‘click’ value=600 eur/(36 month*(5/month+15/month))=0.83 eur

‘A’ specific reward to ‘B’=5/month*0.83 eur/month*0.3=1.25 eur/month

On the other hand, let us assume there is also student ‘C’ with similar education plan. ‘C’ has consumed the aforesaid video of ‘B’ for one time only during the same month but has not accessed any other course materials.

For student ‘C’, the ‘click’ value is then:

600 eur/(36 month*1/month)=16.66 eur/month,

whereupon

‘C’ specific reward to ‘B’=1/month*16.66 eur/month*0.3=5 eur/month.

Accordingly, the total reward to ‘B’ would be the sum of the above student-specific rewards, i.e. 1.25 eur+5 eur=6.25 eur during that past month.

A person skilled in the art shall acknowledge the above was only one option for determining the magnitude of reward and there are other options, which may incorporate both financial and/or non-financial aspects.

In general, one preferred idea resides in dividing the overall education, term or course fee of a user (student) into a plurality of temporal blocks (reporting periods) of preferably equal length, each block being then initially allocated with a preferably equal share of the overall price or fee of the education/course. This, e.g. monthly, share of the overall fee contains at least a portion to be remitted to a number of content provider(s) the material(s) of whom the user has accessed during the block.

The more detailed distribution of the fee among one or more, preferably all, content providers concerning the monitored temporal block may be then executed on a user basis, i.e. user-specifically, which was also represented above.

Per user, the aforesaid distribution may be particularly made dependent on the number of accesses to data ensembles of different content providers.

For example, a user-specific reward allocated to a first content provider may be made positively (i.e. with increasing effect) dependent on the number of accesses of digital data ensemble(s) associated with the first content provider by the user concerned. Yet, not just an increase in the access count of ensembles provided by the first content provider but also an increase in the proportional share of the accesses of ensembles of the first content provider in the aggregate number of accesses of any ensemble of any provider may be required to increase the reward to the first content provider resulting from the activities of the user concerned.

For example, in the above example, if student ‘C’ was just repeatedly accessing the aforementioned video of content provider ‘B’ for 50 more times during the monitoring period, the content provider ‘B’ would still receive only the 5 eur reward from the content access activities of user ‘C’ as the proportional share of materials of provider ‘B’ in the aggregate number of all accessed materials remained unaltered even if the aggregate number as such increased. The increase in the number of ‘clicks’ to the materials of provider ‘B’ was in practice compensated by the corresponding decrease in the ‘click’ value itself.

However, if student ‘A’ was accessing the video of ‘B’ for few additional times during the monitoring period, those additional accesses would increase the student ‘A’-specific reward to be allocated to ‘B’ due to the proportional share of the accesses of the ensembles of ‘B’ elevated in the overall access activities of ‘A’.

Item 316 is thus preferably executed for each user (student). The total reward to a certain content provider may be then determined or the alternatively, the reward may be directly awarded in user-specific or other portions. As a course may span many reporting periods, the execution may be then repeated for each period, depending on the desired rewarding resolution. Meanwhile, the course material may receive updates and revisions by the content providers (item 306). The associated ranking and recommendation data may be updated as well. The repetitive nature of the execution of various method items is highlighted in the flow diagram by a broken loop-back arrow.

The final calculations of the reward shall indeed be made after a concerned monitoring period has already ended because the situation may still evolve as the users may access materials until the end of the period, but estimates covering the whole period and/or partial calculations covering the already accrued portion of the ongoing period only may be in some embodiments still provided. Accordingly, the content providers may obtain up-to-date knowledge about the access statistics around the course materials, i.e. data ensembles, they have provided and potential related rewards.

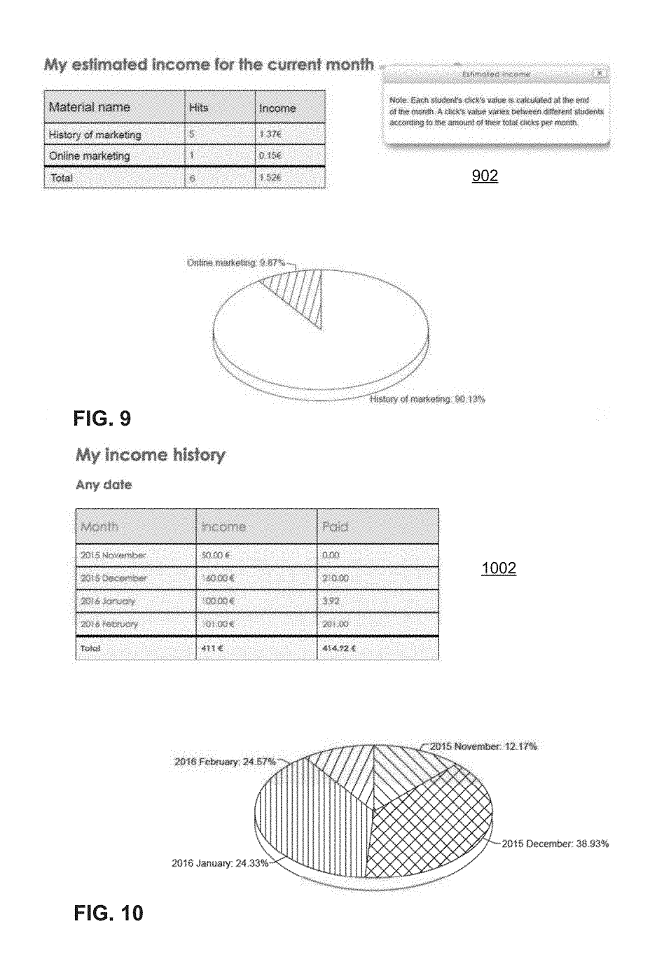

FIGS. 9 and 10 represent at 902 and 1002 two embodiments of award estimation and more definite award determination, respectively. The estimated financial award covering the whole reporting period may be based on the factually already accrued part thereof with a presumption that the situation remains unchanged during the remaining portion of the period. Alternatively, a selected method of extrapolation could be utilized to determine a likely total award for the whole period by extrapolating e.g. the number of accesses user-specifically and their distribution among the data ensembles. For the purpose, besides or instead of existing data for the current period, further historical behavioral data (access data of users e.g. in the form of profile/model data) could be exploited.

Through the view of FIG. 10, the actually realized award may be investigated e.g. by a content provider preferably using a selectable temporal resolution (e.g. monthly or annual status) and/or a preferred visualization technique (e.g. pie chart, curves, bar diagrams, mere financial figures/numbers).

In various embodiments, the operator(s) of the arrangement may be further provided with a tailored UI through which they can actuate payments towards different content providers either provider-specifically or to all providers by a single action such as ‘click’ of an associated icon. For the payments, a selected online payment system such as Paypal™ may be utilized and an interface therefor thus provided via the arrangement.

As discussed hereinbefore, the rewards may include, in addition to or instead of financial compensation, also other form of rewarding such as (elevated) access to digital content or service(s). Yet, the rewards may include tangible, physical items the ownership or usage right of which is transferred to a content provider.

Notwithstanding the type of the reward, the arrangement may, following determination of a reward or total reward, execute the related payment and/or other type of a reward. The process may involve sending a message, such as an e-mail or other proprietary message, or generally a signal to a remote apparatus or system such as a payment operator including e.g. payment or other rewarding instructions. The content provider may be informed via the UI of the arrangement and/or via other messaging. Signaling may occur automatically, e.g. upon expiry of a monitored period and after completing the reward determination. Alternatively, the execution may be triggered manually e.g. by the operator as explained above via applicable UI features.

Item 314 of FIG. 3 refers to feedback acquisition and analysis. User feedback may be received via a number of feedback provision features supported by the arrangement and e.g. related client UIs such as a native client application UI and/or a browser-based UI.

The feedback provision features may include at least one element selected from the group consisting of:

numeric scale (e.g. from 1 to 5 or from 1 to 10, the extremes indicating maximum satisfaction and dissatisfaction, wherein a larger number may indicate more positive feedback or vice versa),
symbolic scale or single, i.e. binary, indication (e.g. thumb up symbol indicative of positive feedback, and thumb down negative, or a number of symbols such as stars selected from a total number of symbols, such as from the total of five, the number in most embodiments increasing with the user satisfaction; obviously such symbolic scale based feedback is then easy to convert into numerical format for e.g. storage and ranking purposes by the arrangement, whereupon visualization is again possible using symbolic representation if desired), and
free-form feedback such as free-form textual feedback provided e.g. via a text box via the UI.

In some embodiments, free-form textual feedback may be subjected to text analysis, or in the case of speech input to speech recognition, to derive qualitative opinion therefrom for determining the underlying grade and/or ranking of the concerned data ensemble.

With reference to both 312 and 314, the grades given, other forms of feedback obtained and/or monitored usage data such as content access history may be utilized in profiling or modeling the concerned user or a greater userbase (user group) by a selected AI method, for example. The resulting user preference data may be then utilized in providing content recommendations in terms of e.g. preferred content type (e.g. visual vs. aural) and/or preferred content provider (preferred content providers vs. disliked providers based on feedback). It may be also tracked whether one or more data ensembles regarding certain learning objectives that are supposed to be studied in some particular sequence or order (e.g. basic concepts of digital marketing->to be followed by the study of more specific objectives regarding different solutions for digital marketing) have already been accessed by a user. If that is the case, the arrangement controlling the online platform may be configured to recommend or at least give additional weight to a data ensemble covering a learning objective next in the sequence.

Also in general sense, the arrangement is preferably configured to keep track of the already-accessed data ensembles and/or related learning objectives for a user and indicate the related progression via the service UI.

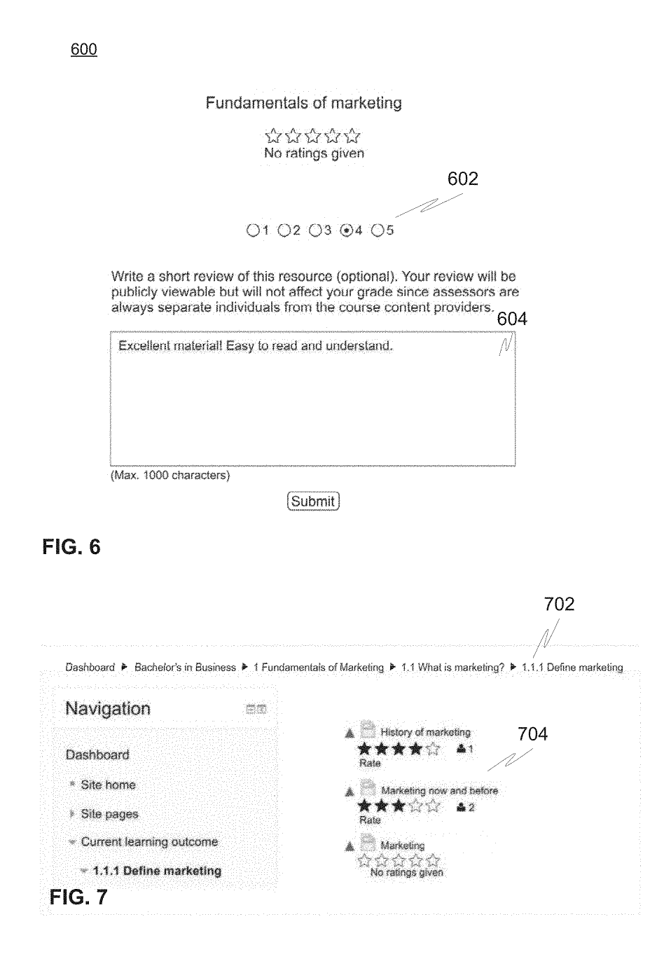

FIG. 6 illustrates at 600 one embodiment following the above general principles for feedback provision and acquisition regarding a data ensemble titled ‘Quantum Physics’. A rating feature 602 of five alternative grades is provided for user selection e.g. in a radio button (shown) or tick box fashion.

Yet, a free-from text feedback feature 604 has been provided. As shown, the existing grade based on previous feedback may be shown in the same view when available (in the depicted case this not being the case, ‘no ratings given’). In some occasions, such indication of an existing common, e.g. average, grade based on earlier feedback (typically by others) may facilitate personal grade equalization as a user who is eager to give feedback may then get an idea of a generally acknowledged rating practice based thereon so that no user is constantly over-positive or overcritical in his/her ratings in contrast to a commonly adopted rating methodology or rating criteria.

With focus back in FIG. 3, the arrangement is preferably configured to determine data ensemble grades and subsequently, at 320, mutual rankings of e.g. alternative data ensembles, i.e. content items covering the same learning objective, based on user feedback such as the nature and/or amount of feedback. Preferably, more positive and/or larger amount of feedback converts into a higher (better) grade and ranking among the ensembles.

Additionally or alternatively, the total number of accesses of a data ensemble of a content provide may affect the ensemble and/or provider grade and/or ranking, preferably such that a larger number converts into a higher grade and/or ranking.

Generally, the feedback and access statistics affecting e.g. rankings may cover a period shorter or longer than the current reporting period. The statistics may have been gathered since the initial publication of the course material, for example.

In some embodiments more recent usage, feedback and/or recommendations may be given additional weight in rating and/or ranking. For example, more recent numerical feedback may be associated with a larger multiplier in the determination of an average grade based on which the ranking is then at least partially constructed.

As mentioned hereinbefore, display or other user-perceivable indication (visual, audible, tactile) of alternative data ensembles at 310 is preferably affected by the mutual ranking of the ensembles, wherein the ranking may be in turn based on the associated grades of the ensembles. Ensembles of higher ranking are generally given priority over lower ranking alternatives in the indication of the ensembles. Alternatively or additionally, only a limited number of higher-ranking ensembles may be first indicated to the users, whereas further ensembles may be optionally visualized in response to a selected user action such as a scrolling or selection action. In some embodiments, only the single, highest ranking ensembles of a plurality of learning objectives are initially represented or indicated to the users via the UI of the arrangement.

Preferably when a plurality of data ensembles is indicated to the users via the UI, data ensembles covering a common learning objective are indicated in isolation (e.g. with spatial separation such as indentation or separate window on a display) or in some other distinguishable fashion having regard to other ensembles, utilizing e.g. a distinguishing color scheme or shape.

In some embodiments, user feedback may be rejected (neglected) or given less weight in determining the grade of a related data ensemble, or ranking thereof. Such approach may be selected through fulfillment of at least one monitored condition selected from the group consisting of: the user giving the feedback has not accessed the target ensemble according to tracking data, the user giving the feedback has not accessed the ensemble for a selected duration, and the user has already previously given feedback regarding the same data ensemble for a selected number of times (at least once).

Additionally or alternatively, and independent of the related learning objectives, general rankings may be constructed and indicated regarding the data ensembles in general, content providers and/or users (students). With users, the ranking or ‘hall of fame’ may be based on the number of data ensemble accesses, for instance. A gamification aspect may be implemented through allocation of ‘experience’ points to users (students) based on the accesses, e.g. number of accesses, duration of accesses, and/or provision of related feedback. The experience may be used to determine the ranking between students. Higher experience may translate into higher ranking and vice versa.

Content provider grade and/or ranking (‘hall of fame’) may be established based on the grades and/or ranking of the related data ensembles, through determining the average of the individual data ensemble grades or rankings, for example. More positive feedback is again advantageously translated into a higher grade and/or ranking. Additionally or alternatively, the sheer number of accesses the data ensembles of a content provider has got, may positively affect the provider grade or ranking according to a selected logic.

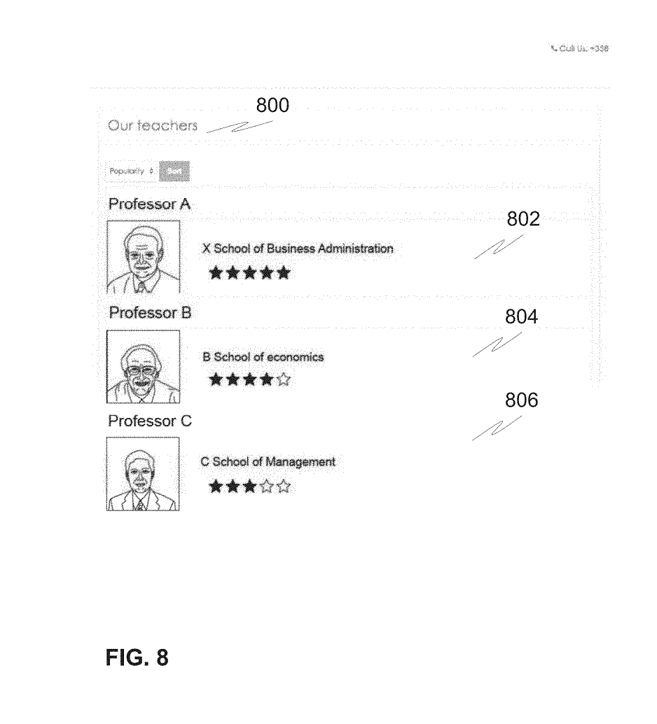

FIG. 8 illustrates an embodiment of a content provider ranking, or ‘hall of fame’. Three content providers 802, 804, 806 have been included with related descriptions (e.g. photograph, personal data or ‘cv’) and personal grades in decreasing order of grade.

Such representation may relate to a certain, user-selected, learning objective only, i.e. the shown providers all supply at least one data ensemble for the objective. However, the shown grades may still be general (cover all ensembles catered for by the providers). In some cases, even if there's no feedback data available yet regarding a certain data ensemble (e.g. a recently published one), the general grade, ranking or various feedback of the associated content provider may yield some hint to an enlightened user as to the possible quality or style of the ensemble.

Alternatively, the hall of fame may be of general type without particular limitation to the availability of data ensembles by the listed content providers on any certain learning objective. Via such representation, the users may preferably access the data ensembles provided by each shown content provider by a selection action such as clicking on the photograph, avatar or other element associated with a content provider. A list of related data ensembles could be then indicated e.g. in decreasing order of data ensemble-specific grade or learning objective-specific ranking (ordinal number).

At 318 of FIG. 3 the method execution is ended.

The scope is defined by the attached independent claims with appropriate national extensions thereof having regard to the applicability of the doctrine of equivalents.

1. An electronic arrangement comprising at least one electronic device or a system of multiple at least functionally connected electronic devices, comprising
data repository configured to store digital online course material for distance learning, provided by a plurality of content providers, said digital course material encompassing course content divided into a plurality of different learning objectives, said digital course material being further arranged into a plurality of separately accessible digital data ensembles each of which addressing a learning objective of said plurality, wherein each learning objective of said plurality is covered by at least one of the plurality of ensembles, and wherein at least one learning objective of said plurality, optionally each learning objective of said plurality, is covered by multiple alternative data ensembles of the plurality of ensembles,
online platform configured to provide online access to a plurality of users regarding said stored digital course material including the plurality of digital data ensembles and communicate indications of multiple alternative ensembles covering said at least one learning objective for enabling related user selection,
access monitor for tracking the usage including access of said digital course material during a selected monitoring period, wherein tracking comprises detecting and storing user-specifically both at least an indication of accessed data ensembles and the cumulative number of related access times per ensemble, and
usage analyzer for determining, based on the stored user-specific indications regarding the monitoring period, user-specific rewards for a content provider of said plurality of providers, and preferably total reward based on the user-specific rewards.

2. The arrangement of claim 1, configured to signal an indication of the determined one or more user-specific rewards or the total reward to an external entity, optionally the content provider or payment operator.

3. The arrangement of claim 1, wherein the usage analyzer is configured to elevate a first user-specific reward to the content provider responsive to detecting an access of a first digital data ensemble associated with the content provider by the first user of said plurality of users while detecting a related increase in a proportional share of the accesses of the first digital data ensemble by the first user in the aggregate number of accesses of any digital ensemble of any content provider of said plurality by the first user.

4. The arrangement of claim 1, wherein the online platform is configured to receive user feedback regarding at least one of said multiple alternative digital data ensembles covering said at least one learning objective and preferably responsive to detected nature of the feedback, the analyzer is configured to determine the mutual ranking of said multiple alternative data ensembles.

5. The arrangement of claim 1, wherein larger amount of feedback classified as positive is translated into a higher ranking among the alternatives.

6. The arrangement of claim 1, wherein larger amount of feedback classified as positive is translated into a higher ranking among the alternatives, wherein the feedback indicates a user-given personal rating for a digital data ensemble of said at least one of said multiple alternative digital data ensembles, subsequently utilized to determine data ensemble-specific overall grade, optionally average or median grade, for use in ranking.

7. The arrangement of claim 1, wherein the online platform is configured to receive user feedback regarding at least one of said multiple alternative digital data ensembles and the analyzer is configured translate a larger amount of feedback into a higher ranking among the alternatives.

8. The arrangement of claim 1, wherein the analyzer is configured to translate a larger number of accesses into a higher ranking among the alternatives.

9. The arrangement of claim 1, wherein the online platform is configured to receive user feedback regarding at least one of said multiple alternative digital data ensembles covering said at least one learning objective and preferably responsive to detected nature of the feedback, the analyzer is configured to determine the mutual ranking of said multiple alternative data ensembles, and further wherein the online platform is configured to communicate indications of higher ranking alternatives to the users prior to, on top of or on the left of the lower ranking alternatives.

10. The arrangement of claim 1, wherein the online platform is configured to receive user feedback regarding at least one of said multiple alternative digital data ensembles covering said at least one learning objective and preferably responsive to detected nature of the feedback, the analyzer is configured to determine the mutual ranking of said multiple alternative data ensembles, and further wherein the analyzer is configured to reject or give less or more weight than default weight in the ranking upon a detected fulfillment of a condition including at least one element selected from the group consisting of: the user giving the feedback has not accessed the ensemble according to tracking, the user giving the feedback has not accessed the ensemble for a selected duration, and the user has previously or frequently according to a selected criterion given feedback regarding the same data ensemble.

11. The arrangement of claim 1, wherein the analyzer is configured to determine, based on user feedback received and/or the total number of accesses of the ensembles of a content provider, user-accessible ranking of the content provider among a plurality of content providers, optionally all content providers.

12. A method for embracing online self-studying-based distance learning to be executed by one or more at least functionally connected electronic devices, preferably comprising at least one server accessible via a communications network, preferably the Internet, said method comprising
storing, at a digital data repository accessible by the devices, digital course material by a plurality of content providers, said digital course material encompassing course content divided into a plurality of different learning objectives collectively covering the content, said digital course material being arranged into a plurality of separately accessible digital data ensembles each of which addressing a learning objective of said plurality,
wherein each learning objective of said plurality is covered by at least one of the plurality of ensembles, and wherein at least one learning objective of said plurality, preferably each learning objective of said plurality, is covered by multiple alternative data ensembles of the plurality of ensembles,
providing online access to said digital course material including the plurality of digital data ensembles for a plurality of users, wherein indications of multiple alternative ensembles covering said at least one learning objective are communicated online for user selection,
tracking the usage including access of said digital course material during a selected monitoring period, wherein tracking comprises detecting and storing user-specifically both at least an indication of accessed data ensembles and the cumulative number of related access times per ensemble, and
determining, based on the stored user-specific indications regarding the monitoring period, user-specific rewards for a content provider of said plurality of providers, and preferably total reward based on the user-specific rewards.

13. The method of claim 12, wherein a first user-specific reward to the content provider is elevated responsive to detecting an access of a first digital data ensemble associated with the content provider by the first user of said plurality of users.

14. (canceled)

15. The method of claim 12, wherein a value of single ensemble access action by a user of said plurality of users during the monitoring period is determined based on monitoring period related overall fee and the overall number of digital data ensemble accesses by the user during the period.

16. The method of claim 12, wherein a first user-specific reward to the content provider is determined based on a value of single ensemble access action of the first user during a monitoring period, the overall number of access actions by the first user to the digital data ensembles of the content provider during the monitoring period and a number of optional additional multipliers.

17. (canceled)

18. (canceled)

19. (canceled)

20. (canceled)

21. (canceled)

22. (canceled)

23. The method of claim 12, wherein user feedback is received and stored regarding at least one of said multiple alternative digital data ensembles covering said at least one learning objective and preferably responsive to detected nature of the feedback, mutual ranking of said multiple alternative data ensembles is determined, further wherein indications of higher-ranking alternatives are communicated to the users prior to, on top of or on the left of the lower-ranking alternatives, and finally wherein indications of one or more highest ranked data ensembles for a plurality of learning objectives of the course content, optionally of substantially all learning objectives, are communicated to the users optionally at one go to enable the users to effortlessly pick out highest-ranking ensemble for each such learning objective.

24. The method of claim 12, wherein mutual ranking of said multiple alternative data ensembles is communicated to users in isolation or at least in visually distinguishable manner from the ranking or visualization of a number of other data ensembles.

25. (canceled)

26. The method of claim 12, wherein substantially free-form user feedback regarding a digital data ensemble is subjected to a text analyzer in connection with textual input or to a speech analyzer in connection with speech input to derive the nature, preferably indication of feedback positivity or negativity, thereof.

27. (canceled)

28. (canceled)

29. The method of claim 12, wherein the user-specific or total reward includes at least one element selected from the group consisting of: elevation of user rights to digital resources, elevation of user rights to digital online resources, provision of access to digital computing and/or data resources, digital file or other asset, financial reward, and digital publication or revision of content provider review, recommendation or ranking.

30. A computer program product embodied in a non-transitory carrier medium comprising instructions causing a computer to:
store, at a digital data repository accessible by the devices, digital course material by a plurality of content providers, said digital course material encompassing course content divided into a plurality of different learning objectives collectively covering the content, said digital course material being arranged into a plurality of separately accessible digital data ensembles each of which addressing a learning objective of said plurality,
wherein each learning objective of said plurality is covered by at least one of the plurality of ensembles, and wherein at least one learning objective of said plurality, preferably each learning objective of said plurality, is covered by multiple alternative data ensembles of the plurality of ensembles,
provide online access to said digital course material including the plurality of digital data ensembles for a plurality of users, wherein indications of multiple alternative ensembles covering said at least one learning objective are communicated online for user selection,
track the usage including access of said digital course material during a selected monitoring period, wherein tracking comprises detecting and storing user-specifically both at least an indication of accessed data ensembles and the cumulative number of related access times per ensemble, and
determine, based on the stored user-specific indications regarding the monitoring period, user-specific rewards for a content provider of said plurality of providers, and preferably total reward based on the user-specific rewards.
